(19) United States
(12) Patent Application Publication
(10) Pub. No.: US 2026/0012805 A1
(43) Pub. Date: Jan. 8, 2026

(54) SPECTRUM CONTROL USING SILENT PERIODS

(71) Applicant: Charter Communications Operating, LLC, St. Louis, MO (US)

(72) Inventor: Abdulrauf Hafeez, Cary, NC (US)

(73) Assignee: Charter Communications Operating, LLC, St. Louis, MO (US)

(21) Appl. No.: 18/762,117

(22) Filed: Jul. 2, 2024

(51) Int. Cl. H04W 16/14; H04W 72/541

(52) U.S. Cl. CPC H04W 16/14; H04W 72/541

(57) ABSTRACT

A spectrum controller controlling use of a spectrum, e.g., the CBRS spectrum, shared by multiple network operators. The spectrum controller sequentially instructs each network operator to implement a silent period during which the network operator (i) ceases transmitting in at least part of the spectrum, and optionally (ii) generates signal-strength measurements of signals from other network operators. The spectrum controller receives the signal-strength measurements from the multiple network operators, generates interference patterns between the multiple network operators, and uses those interference patterns to allocate the spectrum to the multiple network operators, including during times of spectrum usage by incumbents. The interference patterns may be more accurate than conventionally generated interference patterns resulting in more-efficient usage of the shared spectrum by the network operators.

### BACKGROUND

### Field of the Disclosure

The present disclosure relates to wireless communication networks and, more specifically but not exclusively, to multi-network spectrum sharing.

### Description of the Related Art

This section introduces aspects that may help facilitate a better understanding of the disclosure. Accordingly, the statements of this section are to be read in this light and are not to be understood as admissions about what is prior art or what is not prior art.

The Citizens Broadband Radio Service (CBRS) spectrum may be shared by multiple wireless network operators operating in the same geographical area and with incumbents (e.g., government entities) that have priority to access the CBRS spectrum over those network operators. In such a situation, a spectrum controller controls the allocation of channels (i.e., frequency sub-bands) within the CBRS spectrum to the various base stations of those network operators. When incumbent use of at least a portion of the CBRS spectrum is detected, the spectrum controller uses a priori interference patterns to instruct the network operators to stop transmitting or at least reduce the transmit power levels at specified base stations in specified CBRS channels to avoid interfering with the incumbent's communications. Even in the absence of incumbent usage, the spectrum controller uses those interference patterns to control the allocation of CBRS channels to avoid interference between the different network operators.

In some spectrum controller implementations, the determination of how to control CBRS usage is based on very-conservative, predicted interference patterns that tend to overestimate the extent of interference, resulting in less spectrum availability to the network operators than necessary. It is also known to deploy environmental sensing capability (ESC) sensors throughout the relevant geographical area to assess the received signal strength levels at the sensor locations in order to generate the interference patterns used to control CBRS usage.

### SUMMARY

In order to generate more-accurate interference patterns, the present disclosure is related to techniques that involve silent periods (i.e., measurement gaps), whereby the CBRS spectrum controller sequentially instructs network operators to implement silent periods during which the network operator (i) does not transmit in specified channels and (ii) instead, optionally, generates measurements of received signal strength levels in those specified channels. Measurements can also be generated by sensors deployed in the geographic area of network operations. Each network operator or sensor reports its signal measurements and the locations of those measurements to the spectrum controller which uses those multi-network signal measurements to generate the interference patterns used to control the CBRS spectrum during normal network operations and upon the detection of incumbent usage.

In at least one embodiment of the present disclosure, a spectrum controller controls use of a spectrum shared by multiple network operators. The spectrum controller sequentially instructs one or more of the multiple network operators to implement a silent period during which the one or more network operators cease operations on at least part of the spectrum; receives signal-strength measurements corresponding to the silent periods; generates interference patterns between the multiple network operators based on the signal-strength measurements; and allocates the spectrum to the multiple network operators based on the generated interference patterns.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified diagram representing a geographical area in which two different commercial wireless networks respectively operate in the CBRS spectrum with overlapping coverage areas;

FIG. 2 is a flow diagram of the processing performed to generate interference patterns for the network environment of FIG. 1; and

FIG. 3 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

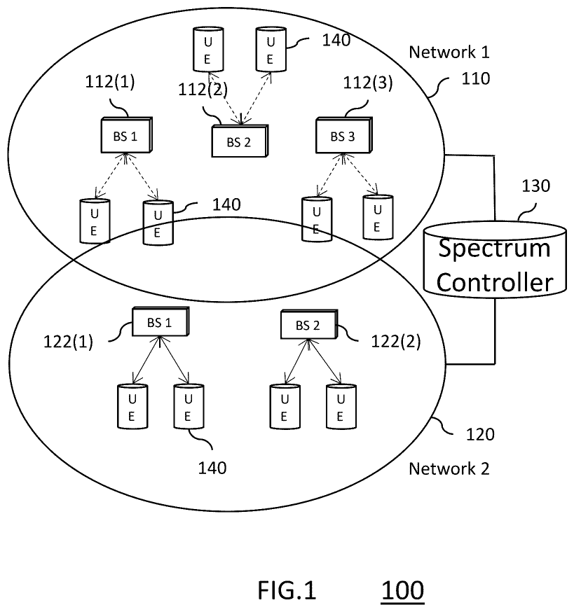

FIG. 1 is a simplified diagram representing a geographical area 100 in which two different commercial wireless networks (Network 1 and Network 2) respectively operate in the CBRS spectrum with overlapping coverage areas 110 and 120. As shown in FIG. 1, spectrum controller 130 controls CBRS usage by assigning CBRS channels to the base stations 112(1)-112(3) of Network 1 and the base stations 122(1)-122(2) of Network 2, where each base station 112/122 is capable of communicating with multiple user equipments (UEs) 140 of subscribers to those networks.

According to certain embodiments of the disclosure, at certain time periods, such as those having relatively low communication levels, the spectrum controller 130 sequentially instructs the network operators to implement silent periods during which the currently instructed network operator (i) does not transmit in specified CBRS channels and (ii) instead generates measurements of received signal strength levels in those specified channels. The network operator reports its signal measurements and the locations of those measurements to the spectrum controller 130 which uses the signal measurements from both network operators to generate the interference patterns used to control the CBRS spectrum during normal network operations and upon the detection of incumbent usage.

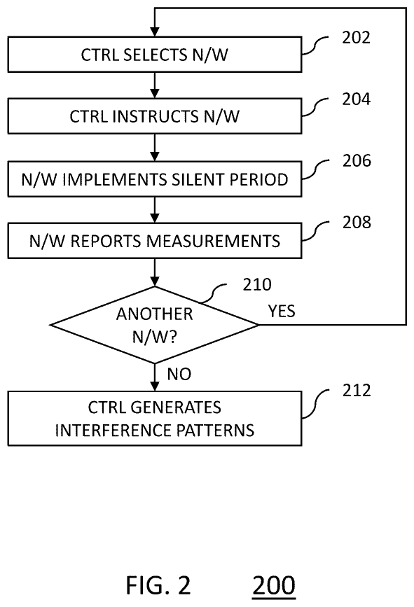

FIG. 2 is a flow diagram of the processing 200 performed to generate those interference patterns. In step 202, the spectrum controller (CTRL) 130 selects one of the networks. In step 204, the spectrum controller 130 instructs the selected network (N/W) to implement a silent period in one or more (and possibly all) specified CBRS channels.

In step 206, for the specified duration of the silent period, the selected network stops transmitting in the specified CBRS channels and instead generates signal measurements in those specified CBRS channels, which are still available for the other network's use. Depending on the particular implementation, the signal measurements may include one or more of (i) signal measurements made at the selected network's base stations, (ii) signal measurements made at ESC sensors (not shown in FIG. 1), and (iii) signal measurements made at the UEs of the selected network and reported to the selected network's base stations. Note that, in situations in which there are three or more network operators that share the CBRS spectrum in the same geographical area, during a silent period implemented by all but one of the networks, the remaining one network is able to transmit in the specified CBRS channels. In step 208, the selected network reports its signal measurements (including information related to the locations at which those measurements were made) to the spectrum controller 130.

In step 210, the spectrum controller 130 determines whether there is another network to select. If so, then processing returns to step 202 to select the next network to implement a silent period. Otherwise, processing proceeds to step 212, where the spectrum controller 130 uses all of the signal measurements from all of the networks to generate the interference patterns. Interference patterns may be generated, for instance, by tuning the propagation models, such as the Irregular Terrain Model (ITM), by adjusting its reliability or confidence parameters so that the propagation loss predicted by the model is in line with the measurements.

Note that, since, typically, not all CBRS channels will always be in use, the processing of FIG. 2 may be repeated (e.g., periodically) in order to collect enough data for all CBRS channels and for all networks over time in order to generate accurate interference patterns. Furthermore, the processing of FIG. 2 may be repeated in order to adjust the interference patterns to evolving CBRS usage patterns.

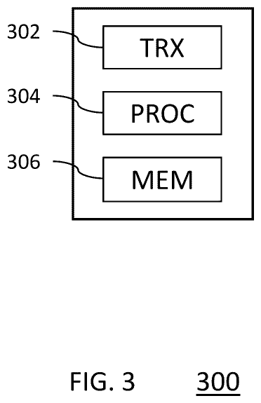

FIG. 3 is a simplified hardware block diagram of an example node 300 that can be used to implement any of the nodes of FIG. 1. As shown in FIG. 3, the node 300 includes (i) communication hardware (e.g., wireless, wireline, and/or optical transceivers (TRX)) 302 that supports communications with other nodes, (ii) one or more processors (e.g., CPU and/or GPU microprocessors) 304 that control the operations of the node 300 and/or process data within the node 300, and (iii) one or more memories (e.g., RAM, ROM) 306 that store code executed by the processors 304 and/or data generated and/or received by the node 300.

Although the disclosure has been described in the context of multi-network environments that share the CBRS spectrum, those skilled in the art will understand that other embodiments of the disclosure may be implemented in the context of other multi-network environments that share other frequency spectra.

In certain embodiments, the present disclosure is a method for a spectrum controller controlling use of a spectrum shared by multiple network operators. The method comprises the spectrum controller sequentially instructing one or more of the multiple network operators to implement a silent period during which the one or more network operators cease operations on at least part of the spectrum; receiving signal-strength measurements corresponding to the silent periods; generating interference patterns between the multiple network operators based on the signal-strength measurements; and allocating the spectrum to the multiple network operators based on the generated interference patterns.

In at least some of the above embodiments, during a silent period, all but one of the multiple network operators cease operations on at least part of the spectrum.

In at least some of the above embodiments, at least some of the signal-strength measurements are received from one of the multiple network operators.

In at least some of the above embodiments, the signal-strength measurements received from the network operator are generated, during a silent period of the network operator, by at least one base station of the network operator and/or user equipments associated with the at least one base station of the network operator.\

In at least some of the above embodiments, at least some of the signal-strength measurements are received from one or more sensors deployed in a geographic area associated with the multiple network operators and/or incumbents.

In at least some of the above embodiments, the spectrum is shared by the multiple network operators and at least one incumbent; and the method further comprises determining incumbent usage of the spectrum and controlling the use of the spectrum by the multiple network operators based on the generated interference patterns to protect the incumbent usage.

In at least some of the above embodiments, the method further comprises aggregating the signal-strength measurements from multiple silent periods for each network operator in order to generate the interference patterns.

In at least some of the above embodiments, the method further comprises updating the generated interference patterns to account for changes in spectrum usage over time.

In at least some of the above embodiments, the spectrum is the CBRS spectrum.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for a spectrum controller controlling use of a spectrum shared by multiple network operators, the method comprising the spectrum controller:
sequentially instructing one or more of the multiple network operators to implement a silent period during which the one or more network operators cease operations on at least part of the spectrum;
receiving signal-strength measurements corresponding to the silent periods;
generating interference patterns between the multiple network operators based on the signal-strength measurements; and
allocating the spectrum to the multiple network operators based on the generated interference patterns.

2. The method of claim 1, wherein, during a silent period, all but one of the multiple network operators cease operations on at least part of the spectrum.

3. The method of claim 1, wherein at least some of the signal-strength measurements are received from one of the multiple network operators.

4. The method of claim 3, wherein the signal-strength measurements received from the network operator are generated, during a silent period of the network operator, by at least one base station of the network operator and/or user equipments associated with the at least one base station of the network operator.

5. The method of claim 1, wherein:
the spectrum is shared by the multiple network operators and at least one incumbent; and
further comprising determining incumbent usage of the spectrum and controlling the use of the spectrum by the multiple network operators based on the generated interference patterns to protect the incumbent usage.

6. The method of claim 1, wherein at least some of the signal-strength measurements are received from one or more sensors deployed in a geographic area associated with the multiple network operators and/or incumbents.

7. The method of claim 1, further comprising aggregating the signal-strength measurements from multiple silent periods for each network operator in order to generate the interference patterns.

8. The method of claim 1, further comprising updating the generated interference patterns to account for changes in spectrum usage over time.

9. The method of claim 1, wherein the spectrum is Citizens Broadband Radio Service (CBRS) spectrum.

10. A spectrum controller comprising:
a memory; and
at least one processor, coupled to the memory and operative to:
sequentially instruct one or more of the multiple network operators to implement a silent period during which the one or more network operators cease operations on at least part of the spectrum;
receive signal-strength measurements corresponding to the silent periods;
generate interference patterns between the multiple network operators based on the signal-strength measurements; and
allocate the spectrum to the multiple network operators based on the generated interference patterns.

11. The spectrum controller of claim 10, wherein, during a silent period, all but one of the multiple network operators cease operations on at least part of the spectrum.

12. The spectrum controller of claim 10, wherein at least some of the signal-strength measurements are received from one of the multiple network operators.

13. The spectrum controller of claim 12, wherein the signal-strength measurements received from the network operator are generated, during a silent period of the network operator, by at least one base station of the network operator and/or user equipments associated with the at least one base station of the network operator.

14. The spectrum controller of claim 10, wherein:
the spectrum is shared by the multiple network operators and at least one incumbent; and
the spectrum controller is further adapted to determine incumbent usage of the spectrum and control the use of the spectrum by the multiple network operators based on the generated interference patterns to protect the incumbent usage.

15. The spectrum controller of claim 10, wherein at least some of the signal-strength measurements are received from one or more sensors deployed in a geographic area associated with the multiple network operators and/or incumbents.

16. The spectrum controller of claim 10, wherein the spectrum controller is further adapted to aggregate the signal-strength measurements from multiple silent periods for each network operator in order to generate the interference patterns.

17. The spectrum controller of claim 10, wherein the spectrum controller is further adapted to update the generated interference patterns to account for changes in spectrum usage over time.

18. The spectrum controller of claim 10, wherein the spectrum is CBRS spectrum.
